(19) United States
(12) Patent Application Publication
(10) Pub. No.: US 2018/0050666 A1
(43) Pub. Date: Feb. 22, 2018

(54) Windshield Wiper Cover

(71) Applicant: Sunil K. Marwaha, Dracut, MA (US)

(72) Inventor: Sunil K. Marwaha, Dracut, MA (US)

(21) Appl. No.: 15/649,000

(22) Filed: Jul. 13, 2017

Related U.S. Application Data
(60) Provisional application No. 62/361,512, filed on Jul. 13, 2016.

(51) Int. Cl. B60S 1/04

(52) U.S. Cl. CPC B60S 1/0491

(57) ABSTRACT

A windshield wiper cover for covering a windshield wiper assembly, where the windshield wiper assembly has a wiper arm mounted proximate a windshield, and a wiper coupled to the arm. The wiper cover includes a sleeve with a closed end and an open end. The sleeve has a length that is greater than the length of the wiper. The sleeve is adapted to be placed over the windshield wiper assembly so as to fully cover the wiper, with the open end of the sleeve on the wiper arm.

### CROSS-REFERENCE TO RELATED APPLICATION

This application claims priority of Provisional application 62/361,512, filed on Jul. 13, 2016, the entire disclosure of which is incorporated herein by reference.

### BACKGROUND

This disclosure relates to windshield wiper covers.

In cold inclement weather, windshield wiper blades can freeze to the windshield. If the wipers are used before the wiper blades thaw, the blades can tear or wear prematurely. Additionally, prolonged direct exposure to sun and heat can degrade the wipers. As the condition of the wipers deteriorates, the driver's visibility degrades, which can lead to danger.

### SUMMARY

All examples and features mentioned below can be combined in any technically possible way.

In one aspect, a windshield wiper cover for covering a windshield wiper assembly, where the windshield wiper assembly comprises a wiper arm mounted proximate a windshield and a wiper coupled to the arm, includes a sleeve with a closed end and an open end, wherein the sleeve has a length that is greater than the length of the wiper. The sleeve is adapted to be placed over the windshield wiper assembly so as to fully cover the wiper, with the open end of the sleeve on the wiper arm.

Embodiments may include one of the following features, or any combination thereof. The sleeve can be made from vinyl-coated polyester fabric material, plastic, PVC, cotton, or any weatherproof/temperature-proof material. The vinyl-coated polyester fabric material may have a weight per square yard of from about 1 ounce to about 20 ounces. The sleeve can be made by folding a length of the material with two long edges lengthwise such that the long edges are on top of each other, and then heat-sealing the long edges and one end together. The sleeve may have a length of about 30 inches. The sleeve may have a width of about 3 inches. The sleeve may have a thickness of about 1 mm.

Embodiments may include one of the following features, or any combination thereof. The windshield wiper cover may further comprise a closure element coupled to or integral with the sleeve proximate the open end. The closure element may be selected from the group of closure elements consisting of a hem, a heat-seal, hook and loop fastener material, an elastic material, a cord, a zipper, a button, and a two-part releasable coupling device. The sleeve can be made from a material selected from the group of materials consisting of vinyl-coated polyester fabric, a plastic film, polyethylene, cotton, latex, and vinyl. The sleeve can be made by folding a length of the material with two long edges lengthwise such that the long edges are on top of each other, and then coupling the long edges and one end together by a process selected from the group of processes consisting of heat-sealing, gluing, and sewing.

### BRIEF DESCRIPTION OF THE DRAWINGS

FIG. 1 is front view of one example of a windshield wiper cover.

FIG. 2 is front view of another example of a windshield wiper cover.

FIG. 3A shows a windshield wiper cover installed on a windshield wiper (with the cover in phantom so as to illustrate the relationship of the cover to the wiper), and FIG. 3B is a perspective view thereof but with the cover fully shown.

### DETAILED DESCRIPTION

The subject windshield wiper cover is constructed and arranged to be used to cover a windshield wiper assembly, where the windshield wiper assembly comprises a wiper aim mounted proximate a windshield, and a wiper coupled to the arm. The windshield wiper cover can inhibit or prevent damage and unnecessary wear to windshield wiper, such as may occur due to snow, ice and sunlight and heat, for example. The windshield wiper cover can be an elongated sleeve with a closed end and an opposite open end. The sleeve is slipped over the end of the wiper arm and slid down until it fully covers the wiper. The open end can be fashioned to close around the wiper arm, to further inhibit snow, sleet, ice, rain, and the like from infiltrating into the sleeve. This closure can be accomplished in any desired fashion, such as by sewing an elastic band or hook-and-loop fabric band or a string or cord into the sleeve near the open end, each of which can be manipulated to gather the sleeve material about the wiper arm. Other closures or fasteners can be used.

The sleeve can be made from a thin waterproof or water-resistant material. The sleeves can have a desired length and width, to accommodate different wiper arms and wipers. Logos, patterns, designs, and symbols can be added on the exterior, such as by printing or a label that is sewn or otherwise fastened to the outside of the sleeve.

The sleeve can be made from vinyl-coated polyester fabric material. The sleeve can alternatively be made from other materials such as a plastic, PVC, cotton, or any weatherproof/temperature-proof material. The vinyl-coated polyester fabric material may have a weight per square yard of from about 1 ounce to about 20 ounces, although it could be lighter or heavier than this. The sleeve can be made by folding a length of the material with two long edges lengthwise such that the long edges are on top of each other, and then coupling the long edges and one end together. This coupling can be accomplished in any known manner, such as by heat sealing, gluing, or sewing. The sleeve is long enough to fully cover the wiper. The sleeve is preferably shorter than the length of the wiper arm, so that the open end is on the wiper arm, somewhere close to where the wiper arm is connected to the vehicle. In one non-limiting example, the sleeve may have a length of about 30 inches. The sleeve may have a width that is sufficient to allow it to be slipped over the windshield wiper assembly. In one non-limiting example, this width is about 3 inches. The sleeve may have a thickness to accomplish a desired level of water resistance and protection from moisture, snow, ice, sleet and sun and heat. In one non-limiting example, this thickness is about 1 mm.

The windshield wiper cover may further comprise a closure element coupled to or integral with the sleeve proximate the open end. The closure element may be selected from the group of closure elements consisting of a hem, a heat-seal, a hook and loop fastener material (e.g., Velcro®), an elastic material, a cord, a zipper, a button, and a two-part releasable coupling device (e.g., a two-part plastic closure structure such as the type commonly used to seal plastic food storage bags). The sleeve can be made from a material selected from the group of materials consisting of vinyl-coated polyester fabric, a plastic film, polyethylene, cotton, latex, and vinyl. The sleeve can be made by folding a length of the material with two long edges lengthwise such that the long edges are on top of each other, and then coupling the long edges and one end together by a process selected from the group of processes consisting of heat-sealing, gluing, and sewing.

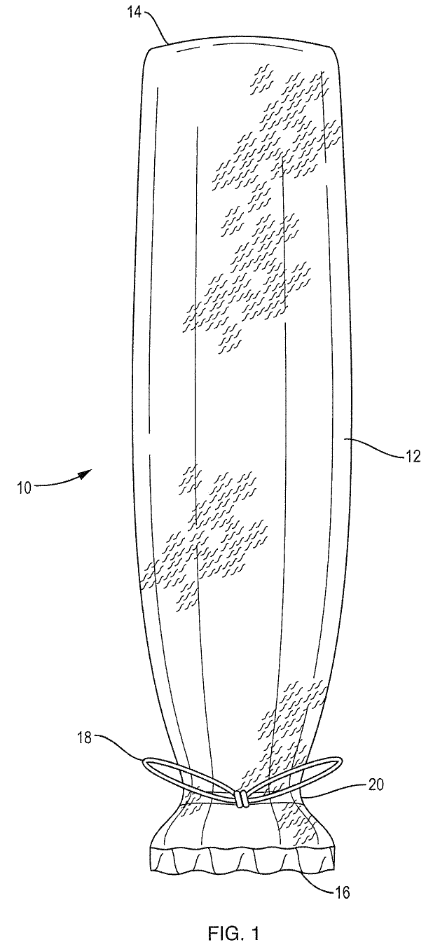

Several non-limiting examples are illustrated in the drawings. Windshield wiper cover 10, FIG. 1, is adapted to be used to cover a windshield wiper assembly, where the windshield wiper assembly comprises a wiper arm mounted proximate a windshield and a wiper coupled to the arm. Windshield wiper cover 10 includes a sleeve 12 with a closed end 14 and an open end 16. Sleeve 12 has a length that is greater than the length of the wiper. Sleeve 12 is adapted to be placed over the windshield wiper assembly so as to fully cover the wiper, with the open end of the sleeve on the wiper arm. Sleeve 12 can be made from vinyl-coated polyester fabric material. The vinyl-coated polyester fabric material may have a weight per square yard of from about 1 ounce to about 20 ounces. Sleeve 12 can alternatively be made from another material, such as a plastic film, polyethylene, cotton, latex, and vinyl.

The sleeve 12 can be made by folding a length of the material with two long edges lengthwise such that the long edges are on top of each other, and then heat-sealing the long edges and one end together to create a tube or sleeve with one closed end 14, leaving the other end 16 open. Alternatively, sleeve 12 can be made by folding a length of the material with two long edges lengthwise such that the long edges are on top of each other, and then coupling the long edges and one end together by a process selected from the group of processes consisting of heat-sealing, gluing, and sewing. Sleeve 12 may have a length of about 30 inches, a width of about 3 inches, and a thickness of about 1 mm. Closure element 18 (at location 20 close to but not at end 16) is coupled to the sleeve proximate the open end, such as by sewing. Closure element 18 in this non-limiting example is a string or cord (i.e., a draw-string) that can be pulled tight and tied off as shown. Closure element 18 can alternatively have a different construction, including but not limited to those described above, such as a hook and loop fastener material, an elastic material, a cord, a zipper, a button, and a two-part releasable coupling device.

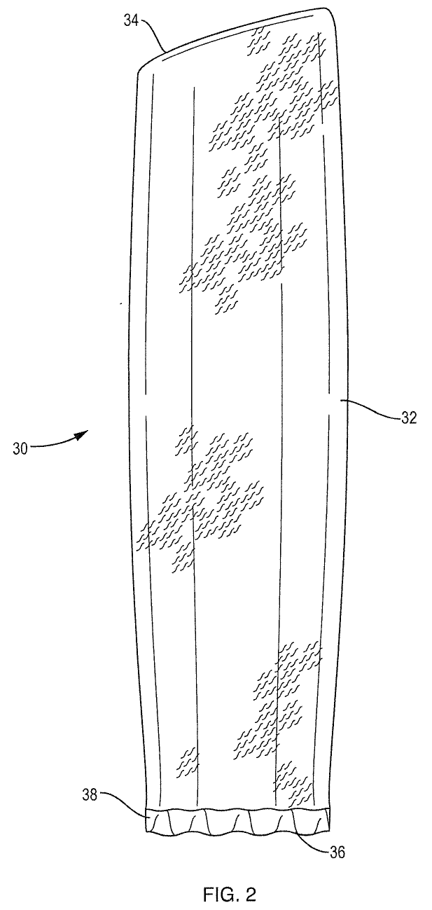

FIG. 2 illustrates a different configuration of windshield wiper cover 30. Sleeve 32 has closed end 34 that is angled, to better fit the end of a wiper assembly. Also, closure 38 near open end 36 in this case is an elastic band that can be stretched to fit over the wiper arm, and when released then bunches up to grip the wiper arm more tightly and close off the open end more than would be the case without the closure element.

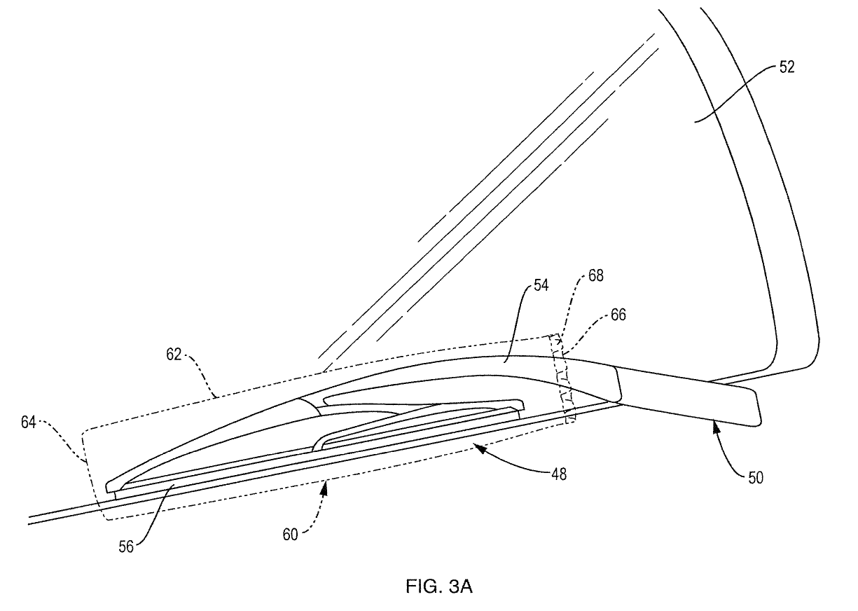

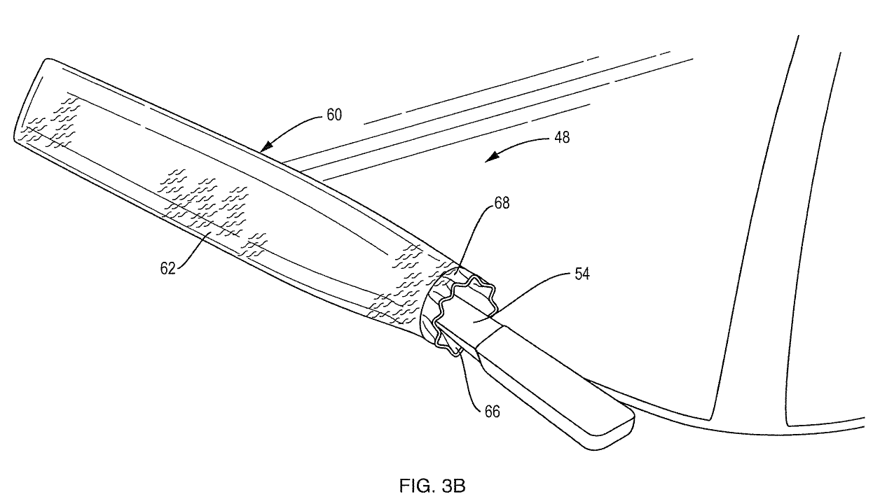

FIG. 3A shows assembly 48 of windshield wiper cover 60 fitted over windshield wiper 50 that has wiper (wiper blade) 56 carried by wiper arm 54. Wiper arm 54 is mounted to the vehicle close to windshield 52, as is well known in the vehicle field. Cover 60 includes sleeve 62 with closed end 64 and open end 66. Elastic or Velcro closure 68 is located at or near open end 66. Sleeve 62 is long enough to fully cover wiper 56. Sleeve 60 is preferably (but not necessarily) short enough such that it does not cover the entire length of wiper arm 54; this allows the end to be coupled to the arm by the closure that is at or near the open end of the sleeve. FIG. 3B is another view that better illustrates open end 66 located over wiper arm 54.

A number of implementations have been described. Nevertheless, it will be understood that additional modifications may be made without departing from the scope of the inventive concepts described herein, and, accordingly, other embodiments are within the scope of the following claims.

What is claimed is:

1. A windshield wiper cover for covering a windshield wiper assembly, where the windshield wiper assembly comprises a wiper arm mounted proximate a windshield and a wiper coupled to the aim, the windshield wiper cover comprising:
a sleeve with a closed end and an open end, wherein the sleeve has a length that is greater than the length of the wiper;
wherein the sleeve is adapted to be placed over the windshield wiper assembly so as to fully cover the wiper, with the open end of the sleeve on the wiper arm.

2. The windshield wiper cover of claim 1, wherein the sleeve is made from one of a vinyl-coated polyester fabric material, plastic, PVC, cotton, or any weatherproof/temperature-proof material.

3. The windshield wiper cover of claim 2, wherein the sleeve is made by folding a length of the material with two long edges lengthwise such that the long edges are on top of each other, and then heat-sealing the long edges and one end together.

4. The windshield wiper cover of claim 3, wherein the sleeve has a length of about 30 inches.

5. The windshield wiper cover of claim 4, wherein the sleeve has a width of about 3 inches.

6. The windshield wiper cover of claim 5, wherein the sleeve has a thickness of about 1 mm.

7. The windshield wiper cover of claim 6, further comprising a closure element coupled to or integral with the sleeve proximate the open end.

8. The windshield wiper cover of claim 7, wherein the closure element is selected from the group of closure elements consisting of a hem, a heat seal, hook and loop fastener material, an elastic material, a cord, a zipper, a button, and a two-part releasable coupling device.

9. The wiper cover of claim 2, wherein the vinyl-coated polyester fabric material has a weight per square yard of from about 1 ounce to about 20 ounces.

10. The windshield wiper cover of claim 1, wherein the sleeve is made from a material selected from the group of materials consisting of vinyl-coated polyester fabric, a plastic film, polyethylene, cotton, latex, and vinyl.

11. The windshield wiper cover of claim 1, wherein the sleeve is made by folding a length of the material with two long edges lengthwise such that the long edges are on top of each other, and then coupling the long edges and one end together by a process selected from the group of processes consisting of heat-sealing, gluing, and sewing.
